(19) United States
(12) Patent Application Publication
(10) Pub. No.: US 2025/0310911 A1
(43) Pub. Date: Oct. 2, 2025

(54) SYSTEMS AND METHODS FOR UPLINK TIMING ALIGNMENT FOR INTER-CELL MOBILITY

(71) Applicant: ZTE CORPORATION, Shenzhen (CN)

(72) Inventors: Xiaolong GUO, Shenzhen (CN); Bo GAO, Shenzhen (CN); Ling YANG, Shenzhen (CN); Ke YAO, Shenzhen (CN); Yang ZHANG, Shenzhen (CN)

(73) Assignee: ZTE CORPORATION, Shenzhen (CN)

(21) Appl. No.: 19/234,575

(22) Filed: Jun. 11, 2025

Related U.S. Application Data
(63) Continuation of application No. PCT/CN2023/076879, filed on Feb. 17, 2023.

(51) Int. Cl. H04W 56/00; H04W 72/232; H04W 74/0833

(52) U.S. Cl. CPC H04W 56/0045; H04W 72/232; H04W 74/0833

(57) ABSTRACT

Presented are systems, methods, apparatuses, or computer-readable media for uplink timing alignment for inter-cell mobility. A wireless communication node of a candidate cell for a wireless communication device can send a configuration associated with the candidate cell, to the wireless communication device. The wireless communication node can receive a transmission sent by the wireless communication device according to the configuration.

### CROSS-REFERENCE TO RELATED APPLICATION

This application claims the benefit of priority under 35 U.S.C. § 120 as a continuation of PCT Patent Application No. PCT/CN2023/076879, filed on Feb. 17, 2023, the disclosure of which is incorporated herein by reference in its entirety.

### TECHNICAL FIELD

The disclosure relates generally to wireless communications, including but not limited to systems and methods for uplink timing alignment for inter-cell mobility.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, a method, an apparatus, or a computer-readable medium for uplink timing alignment for inter-cell mobility. A wireless communication node (e.g., base station (BS), gNB, or transmission and reception point (TRP)) of a candidate cell for a wireless communication device can send/transmit/provide/communicate/signal a configuration associated with the candidate cell to the wireless communication device (e.g., UE). The wireless communication node can receive/obtain/collect/acquire a transmission sent by the wireless communication device according to the configuration.

In some implementations, the configuration can comprise/include a configuration of a random access channel. The transmission can comprise a physical random access channel (PRACH) transmission. In some implementations, the wireless communication device can initiate/start/perform a random access procedure associated with the candidate cell according to the configuration or according to a message from the wireless communication node indicative of at least one PRACH transmission parameter for the candidate cell.

In some implementations, the configuration can comprise a maximum number of PRACH transmissions associated with a random access procedure for TA acquisition of the candidate cell. When the number of PRACH transmissions associated with a random access procedure reaches the maximum number, the random access procedure can be considered as completed unsuccessfully (e.g., failed).

In some implementations, the wireless communication node can receive a message to indicate that a random access procedure is initiated for acquiring timing advance (TA) related information of the candidate cell from a wireless communication device. In some implementations, at least one of: after sending the message, the wireless communication device may not detect (e.g., avoid/skip/disregard detecting) a downlink control information (DCI) format associated with scheduling of a random access response (RAR) associated with the random access procedure, or may not receive the RAR; after sending the message, the wireless communication device may not detect a DCI format associated with scheduling of a physical downlink shared channel (PDSCH) that includes a user equipment (UE) contention resolution identity, or may not receive the PDSCH that includes the UE contention resolution identity; after sending the message, the wireless communication device may not detect a DCI format with cyclic redundancy check (CRC) bits scrambled by a corresponding MsgB radio network temporary identifier (RNTI), or may not receive a MsgB; and/or the message can comprise at least one of: a cell RNTI (C-RNTI), a random access RNTI (RA-RNTI), a MsgB RNTI, a random access preamble index, and/or a candidate cell index.

In some implementations, the wireless communication node may send a message indicative of terminating or completing a random access procedure or successfully receiving a PRACH transmission after reception of Msg1, Msg3 or MsgA to the wireless communication device, where at least one of: the wireless communication device may not detect a downlink control information (DCI) format associated with scheduling of a random access response (RAR) associated with the random access procedure, or may not receive the RAR; the wireless communication device may not detect a DCI format associated with scheduling of a physical downlink shared channel (PDSCH) that includes a user equipment (UE) contention resolution identity, or may not receive the PDSCH that includes the UE contention resolution identity; the wireless communication device may not detect a DCI format with cyclic redundancy check (CRC) bits scrambled by a corresponding MsgB radio network temporary identifier (RNTI), or may not receive a MsgB; and/or the message can comprise a DCI format with CRC bits scrambled by a cell RNTI (C-RNTI), a random access RNTI (RA-RNTI) or a MsgB RNTI, or a DCI format with an indication field having bits set to specific values, or a DCI format with a specific indication field, or a specific medium access control control element (MAC CE) signaling.

In some implementations, at least one of: the wireless communication node can send a random access response (RAR) message indicative of terminating or successfully completing a random access procedure to the wireless communication device, where the RAR message can indicate at least one of: a physical cell index (PCI), a candidate cell index, a flag of whether to complete or terminate the random access procedure, and/or a timing advance (TA) related information; the wireless communication node can send a configuration to enable or disable the wireless communication device to perform partial random access procedure to the wireless communication device, where when performing the partial random access procedure is enabled, performing one or more steps/procedures/features discussed herein, and/or when performing the partial random access procedure is disabled, random access can be performed according to a 2-step type random access or a 4-step type random access procedure; the wireless communication node can send one or more RAR messages to the wireless communication device, where each of the one or more RAR messages may indicate TA related information associated with a corresponding candidate cell, and the wireless communication device can determine uplink transmission timing associated with the corresponding candidate cell indicated by a cell switch message based at least on the TA related information associated with the corresponding candidate cell; and/or the wireless communication node can send a cell switch message to the wireless communication device, the cell switch message indicating at least one of: a cell index, and/or TA related information associated with the cell index.

In some implementations, at least one of: the wireless communication node for transmission of a random access preamble can determine a random access network temporary identifier (RA-RNTI) associated with a PRACH occasion in which the random access preamble is transmitted, as a function of an index of the candidate cell associated with the transmission of the random access preamble (cell_id); and/or the wireless communication node for transmission of a MsgA can determine a MSGB network temporary identifier (RNTI) associated with a PRACH occasion in which the random access preamble is transmitted, as a function of the cell_id, and a cell_total, where cell_total may be a maximum number of candidate cells supported according to a capability of the wireless communication device, or a number of configured candidate cells, or a defined value, and cell_id is an integer value equal to or larger than zero, and smaller than or equal to a value of cell_total, and the defined value is one from {1, 2, 3, 4, 5, 6, 7}.

In some implementations, the wireless communication node can send a configuration to configure the wireless communication device with a timing advance (TA) related timer for the candidate cell to the wireless communication device, where when the timing advance related timer expires, the wireless communication device may initiate a random access procedure associated with the candidate cell.

In some implementations, at least one of: the configuration can comprise a configuration of one or more sounding reference signal (SRS) resources or SRS resource sets associated with timing advance (TA) acquisition; the transmission comprises a SRS transmission; the SRS transmission is for uplink timing advance acquisition for the candidate cell; and/or the one or more SRS resources or SRS resource sets can be associated with at least one of: the candidate cell, and/or a downlink reference signal (DL-RS) of the candidate cell.

In some implementations, the wireless communication node can receive the SRS transmission from the wireless communication device, where least one of: the SRS transmission may correspond to an SRS activation or deactivation medium access control control element (MAC CE) signaling or a downlink control information (DCI) signaling; a field in the SRS activation or deactivation MAC CE signaling or the DCI signaling can indicate that the SRS transmission is activated or triggered for timing advance acquisition of the candidate cell; and/or the SRS transmission may be associated with the candidate cell.

In some implementations, the wireless communication device can determine uplink transmission timing of the SRS transmission, associated with timing advance acquisition for the candidate cell, based at least on a timing advance value and a downlink timing, where at least one of: the timing advance value can comprise: (i) zero, (ii) a timing advance value associated with a source cell, (3) a timing advance value associated with a cell different from the candidate cell, and/or (4) a timing advance value associated with the candidate cell; and/or the downlink timing can comprise: (i) a downlink timing associated with the source cell, (ii) a downlink timing associated with the candidate cell, and/or (iii) a downlink timing associated with a cell different from the candidate cell.

In some implementations, at least one of: after the SRS transmission for uplink timing advance acquisition, the wireless communication device can receive a message indicative of an index of the candidate cell, and cancels an activated or triggered transmission of SRS for uplink timing advance acquisition associated with the candidate cell; or the wireless communication device may not receive the message indicative of the index of the candidate cell within a time period relative to the SRS transmission for uplink timing advance acquisition associated with the candidate cell, where the time period can be configured for an SRS resource, an SRS resource set or the candidate cell associated with the SRS transmission, and may transmit another message to the wireless communication node to indicate that the uplink timing advance acquisition for the candidate cell has failed.

At least one aspect is directed to a system, a method, an apparatus, or a computer-readable medium. A wireless communication device (e.g., UE) can receive a configuration associated with the candidate cell from a wireless communication node (e.g., BS, gNB, or TRP). The wireless communication device can send a transmission to the wireless communication node according to the configuration.

The systems and methods presented herein include a novel approach for uplink timing adjustment for inter-cell mobility. Specifically, the systems and methods presented herein discuss a novel solution for UEs (e.g., wireless communication devices) to acquire/obtain/receive a timing advance value for at least one candidate cell, such as in instances/cases/scenarios where the UE is requesting a cell switch. For example, the systems and methods of the technical solution can provide techniques for performing partial random access procedures to acquire timing advance value, defining sounding reference signal (SRS) transmission-based methods/procedures/steps/features to acquire timing advance value, and/or defining downlink timing difference-based methods to acquire timing advance value.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates a deployment scenario for inter-cell mobility, in accordance with an illustrative embodiment;

FIG. 4 illustrates a block diagram of timing advance management for inter-cell mobility, in accordance with an illustrative embodiment; and

FIG. 5 illustrates of a flow diagram of a method for uplink timing alignment for inter-cell mobility, in accordance with an illustrative embodiment.

### DETAILED DESCRIPTION

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 1. Mobile Communication Technology and Environment

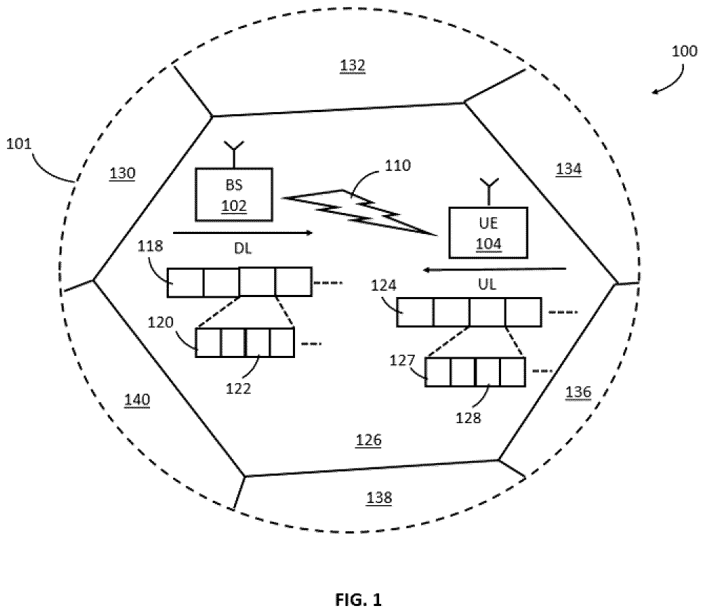

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

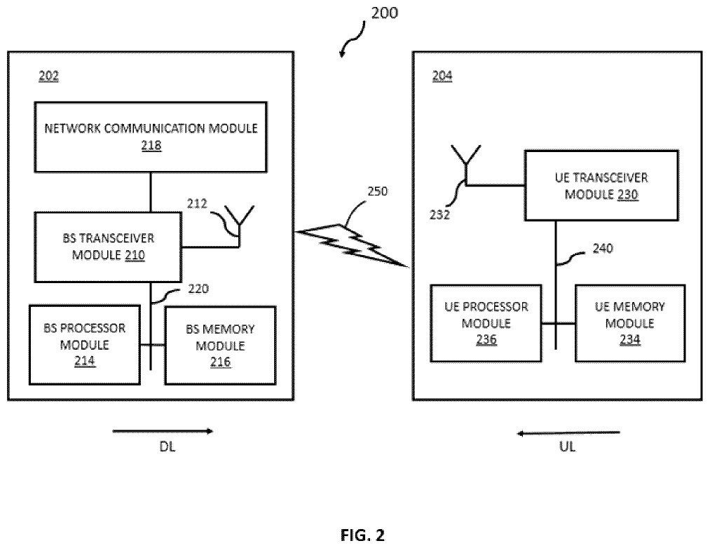

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuity that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (cNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

### 2. Systems and Methods for Uplink Timing Alignment for Inter-Cell Mobility

In certain systems, UE mobility (e.g., mobility of/for the UE 104) may refer to or be defined to be the handover from one cell (e.g., NR cell) to another cell. The handover can be performed based on or according to the measurement of synchronization signals associated with different cells and/or transmission and reception points (TRPs). For certain types of mobility (e.g., layer-3 based mobility) or systems, downlink (DL) and uplink (UL) synchronization (e.g., DL/UL synchronization) may be performed after or subsequent to the handover of the UE 104 to another cell, resulting in a relatively large delay for cell switch. For certain other types of mobility (e.g., layer1 and/or layer-2 based mobility), when the UE 104 is configured for one or more candidate cells, the UE 104 may perform downlink and/or uplink synchronization for a candidate cell prior to or before cell switch. In this case, the downlink and/or uplink synchronization may be established before the UE receives the cell switch command message, thereby reducing/minimizing the delay for cell switch.

Uplink synchronization can ensure or enable the arrival timing of transmissions from multiple UEs 104 to be within an acceptable/satisfactory range, and/or ensure the demodulation at network side (e.g., BS-side) can be reliable. Uplink synchronization can be based on, according to, or relied on an indication message/signal from the BS 102 (e.g., network) and/or a measurement at the UE side. The indication message may be determined/obtained/acquired/identified at BS side based on uplink channels/signals from the UE 104, e.g., PRACH and/or SRS, among other types of signals. The measurement at the UE side can be based on the reception timing of downlink signals/channels. When uplink synchronization for one or more candidate cells is to be performed, it may be desired to acquire (e.g., by the UE 104) a timing advance value associated with each of the candidate cells, such as before or during cell switching to reduce/minimize the delay or latency for cell switch.

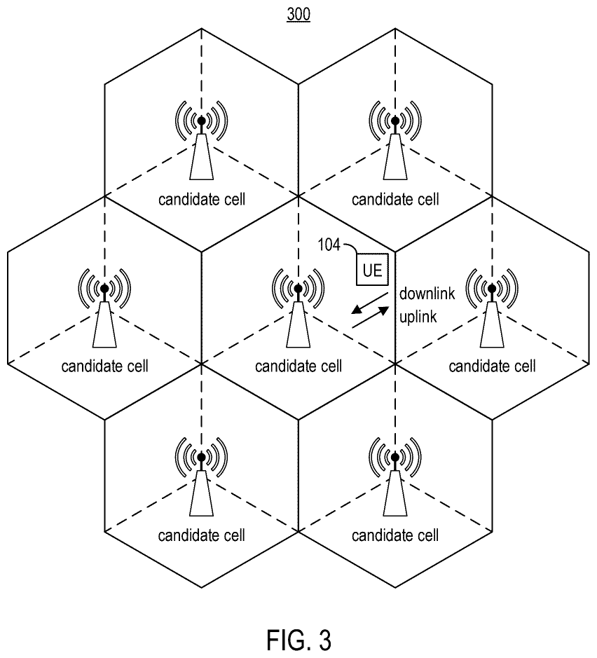

Referring to FIG. 3, depicted is a deployment scenario 300 for inter-cell mobility. Downlink and/or uplink synchronization can be one of the steps/processes/procedures for ensuring reliable wireless communication in various wireless systems, such as for reliable communication between at least one UE 104 and at least one BS 102. In certain scenarios, downlink synchronization may be realized/initiated by or responsive to receiving/acquiring/obtaining a primary synchronization signal (PSS) and/or secondary synchronization signal (SSS). The uplink synchronization may be realized by or responsive to a random access procedure and/or uplink timing alignment maintenance. The uplink timing alignment maintenance can be based on timing advance command (TAC) transmitted/sent/provided/signaled/communicated by the BS 102.

As shown in FIG. 3, when the UE 104 is communicating with a current serving cell (e.g., source cell or the cell currently connected to or serving the UE 104), the UE 104 can be configured for multiple candidate cells. With the UE mobility (e.g., movement of the UE 104), the UE 104 may desire or be forced to switch to a candidate cell from the source cell. In such cases, the UE 104 may perform/initiate/execute downlink and/or uplink synchronization for at least one candidate cell.

For certain UEs 104, the certain UEs 104 may determine one or more timing advance values according to the number of time alignment groups (TAGs). The BS 102 can configure/set one or more TAGS to indicate at least one TAC for one or more serving cells in carrier aggregation scenarios. Each TAG can include/contain or be configured for one or more serving cells. The BS 102 may transmit at least one TAC associated with at least one TAG to the UE 104. The UE 104 can apply/initiate/execute the TAC to determine/identify the timing advance for the various serving cells in or associated with the TAG.

For each TAG, the UE 104 can obtain the initial timing advance value based on a random access procedure (e.g., by performing the random access procedure). When the UE 104 receives/acquires/obtains a TAC medium access control (MAC) control element (CE) (e.g., TAC included/contained in or provided via MAC CE), the UE 104 may update/adjust/configure the timing advance value based on or according to the TAC MAC CE and/or the current timing advance value.

In various aspects discussed herein, the term source cell can refer to, correspond to, or be described as serving cell. The term candidate cell can refer to non-serving cell, target cell, or neighbor cell. The term index of a cell, a source cell, or a candidate cell can be represented by a serving cell index, a physical cell index, or a candidate cell index, for example. The term source cell or candidate cell can include/comprise, describe, or refer to at least one of “information grouping one or more reference signals”, “reference signal resource set”, “PUCCH resource set”, “antenna port group”, “physical cell index (PCI)”, “TRP related information”, “CORESET pool index”, TAG, “UE capability value,” and/or “UE capability set”. The term MsgB can include or refer to an absolute timing advance command MAC CE. The term uplink signal can include or correspond to at least one of, but is not limited to, physical uplink control channel (PUCCH), physical uplink shared channel (PUSCH), sounding reference signal (SRS), and/or physical random access channel (PRACH), among others. The term PRACH transmission can refer to MSG1 transmission, MSGA transmission, and/or random access preamble transmission. The term uplink transmission can refer to or correspond to a transmission occasion of an uplink signal, a repetition of an uplink signal, or an uplink signal. The term downlink reference signal (DL-RS) may include, refer to, or correspond to channel state information (CSI) reference signal (RS) and/or synchronization signal block (SSB), among others. The term timing advance-related information can include/comprise at least one of: a cell index, a time alignment group (TAG) index, a timing advance command, a timing advance offset, and/or a timing advance offset command.

In various arrangements, the cell index can be a serving cell index, a physical cell index, and/or a candidate cell index. The timing advance command may be carried in MAC RAR and/or TAC MAC CE to indicate, for instance, adjustment value for timing advance. The timing advance offset may be configured for a serving cell to adjust uplink transmission timing. The timing advance offset command can be used/configured/provided to indicate the timing advance adjustment offset value between TACs and/or TA values. The term timing advance acquisition may refer to uplink timing alignment.

A series or sequences of approaches to acquire/obtain uplink timing advance value for a candidate cell can be considered in the following aspects: random access procedure-based, SRS transmission-based, and/or downlink timing difference-based procedures/aspects/methods/configurations. In some configurations, in/for the random access procedure-based configuration, the UE 104 may initiate/start a random access procedure associated with a candidate cell for timing advance acquisition. The BS 102 (e.g., network of the candidate cell) can determine a timing advance-related information based on the PRACH transmission from the UE 104. The BS 102 can transmit a message/signal/information to the UE 104. The message can be MsgB, Msg2, MAC RAR, and/or MAC CE indicating to complete the random access procedure. The UE 104 can determine a timing advance value or determine to complete a random access procedure based on the message from the BS 102.

In some configurations, in the SRS transmission-based configuration, the UE 104 may be configured with one or more SRS resources. In this case, the UE 104 can transmit an SRS for uplink timing acquisition of a candidate cell. Responsive to receiving the SRS, the BS 102 can determine a timing advance-related information based on the SRS transmission from the UE 104. The BS 102 can transmit a message to the UE 104, where the message can be TAC MAC CE or a MAC CE/downlink control information (DCI) format indicating to cancel/terminate SRS transmissions for uplink timing advance acquisition. The UE 104 can determine a timing advance value or determine to cancel SRS transmissions based on or according to the message from the BS 102.

In some configurations, in the downlink timing difference-based configuration, the UE 104 may receive one or more downlink reference signals associated with at least one cell. Responsive to receiving the downlink reference signals, the UE 104 can determine the downlink timing of the cell. The UE 104 can determine the difference between the downlink timing of a first cell and a second cell. The UE 104 can determine the timing advance value associated with the second cell based on the difference and the timing advance value associated with the first cell. The UE 104 can receive a message (e.g., from the BS 102) indicative of a timing advance adjustment information. Responsive to receiving the message, the UE 104 can determine to adjust timing advance value according to the message.

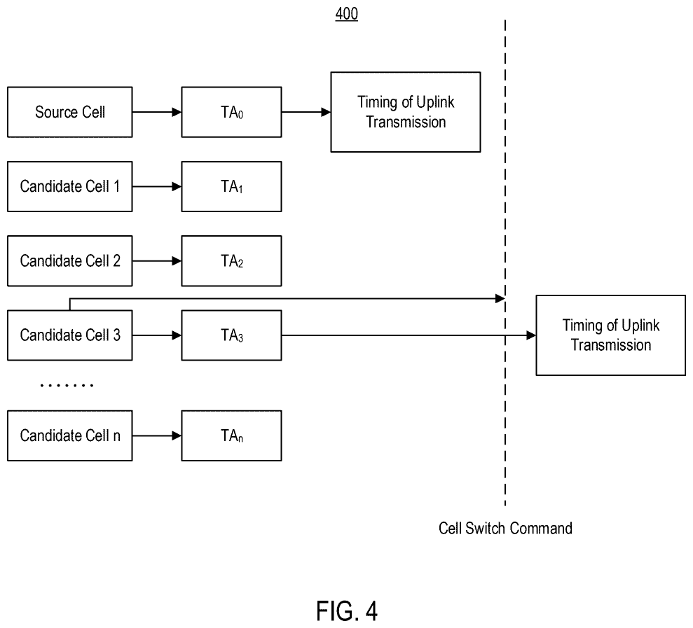

In various implementations, the UE 104 can be configured with/to one or more candidate cells (e.g., communicate with one or more BSs 102 associated with different candidate cells). In this case, the UE 104 can perform uplink time alignment for at least one of the one or more candidate cells. The UE 104 can transmit uplink transmissions associated with a first cell and adjust/change/update transmission timing of the uplink transmissions based on a first timing advance-related message. When the UE 104 receives a cell switch message from a respective BS 102 indicative of a second cell, the UE 104 can transmit uplink transmission associated with the second cell and adjust transmission timing of the uplink transmission based on or according to a second timing advance-related message. In this case, the first cell can be associated with or refer to the source cell, and the second cell may be associated with or refer to one of the candidate cells. The second timing advance-related message can be determined/identified based on at least one of the methods/features/implementations as discussed herein (e.g., in conjunction with FIG. 4).

Referring to FIG. 4, depicted is a block diagram 400 of timing advance management for inter-cell mobility. As shown, before/prior to the UE 104 receiving a cell switch command/indication/message, the transmission timing of/for uplink transmissions can be determined by or according to the timing advance value acquired for the source cell (e.g., current cell serving the UE 104. The UE 104 can acquire/obtain/receive multiple timing advance values for multiple respective candidate cells (e.g., potential cells for cell switching). Responsive to or once the UE 104 receives a cell switch command, the UE 104 can determine the transmission timing of uplink transmissions according to the timing advance value acquired for the candidate cell indicated by the cell switch command. The timing advance values for the other candidate cells can be cleaned, considered invalid, discarded, or maintained/kept without a further update.

In various implementations discussed herein, when the UE 104 receives a timing advance-related message from a BS 102 associated with a candidate cell, the UE 104 can determine a new timing advance value associated with the candidate cell based on the timing advance-related message and/or based on the current timing advance value associated with the candidate cell. The candidate cells (e.g., to perform/initiate the uplink time alignment) can be configured by the BS 102 (e.g., network device, wireless communication node, gNB, or TRP of a certain candidate cell).

For example, the uplink time alignment can be enabled in the configuration of a candidate cell (e.g., by the BS 102). In another example, a set of candidate cell indexes can be configured to perform uplink time alignment. In various configurations, the number of candidate cells to perform the uplink time alignment can correspond to or equal to at least one of the number of candidate cells configured to/for the UE 104, a value according to the UE capability/setting/performance, a predefined value, and/or a configured value, for example.

### Example Implementation 1: Timing Advance-Related Message based on Random Access (RA) Procedure

In various configurations, the systems and methods of the technical solution discussed herein can involve determining and/or indicating the timing advance-related information associated with a candidate cell based on a random access procedure. The UE 104 can determine the timing advance value associated with the candidate cell based on or according to a message (e.g., the timing advance-related information) from the BS 102. The message can be determined by the BS 102 based on the transmission of the PRACH from the UE 104. The information can be carried in a random access response (RAR) or a cell switch command.

In some aspects, before/prior to initiating the physical random access procedure, the UE 104 can be configured (e.g., by the BS 102) with one or more random access channel configurations for one or more candidate cells. The random access channel configuration can include at least one of: random access (RA) preamble indexes, RA-radio network temporary identifier (RNTI), PRACH resources, the target power level/threshold at the network receiver side (e.g., BS side), a max number of RA preamble transmission performed before declaring a failure (e.g., preambleTransMax), synchronization signal block (SSB) index, candidate cell index, and/or physical cell index (PCI). To configure the UE 104, for example, the BS 102 (of a candidate cell for the UE 104) can send a configuration (e.g., random access channel configuration) associated with the candidate cell to the UE 104. The one or more random access channel configurations for one or more candidate cells can be associated with cell specific random-access parameters configured in RACH-ConfigCommon and/or dedicated random access parameters configured in RACH-ConfigDedicated, and/or can be configured individually.

In some cases, a request for/of a PRACH transmission can be associated with a configuration of one or more candidate cells and/or an indication of timing advance (TA) acquirement (e.g., the indication to acquire/obtain the TA) of one or more candidate cells. The UE 104 can initiate/start/execute a random access procedure associated with a candidate cell based on or according to the random access channel configuration (e.g., sometimes referred to generally as a configuration) for the candidate cell (e.g., contention-based RA) and/or based on a message from the UE 104. In this case, the message from the UE 104 can indicate at least one PRACH transmission parameter for the candidate cell (e.g., contention-free based RA).

In some cases, the UE 104 may initiate a random access procedure according to a message (e.g., PDCCH order) from the BS 102. In this case, the message can include an indication field to provide an indication of random access procedure initiation/performing for a cell. In certain configurations, the field can be set/configured to 1, for instance, to indicate that the random access procedure is initiated or performed for a candidate cell. The field can be set to 0 to indicate that the random access procedure is initiated or performed for the serving cell. Alternatively, the field can be configured with the other binary number indicating whether the random access procedure is initiated for the candidate cell or the serving cell, such as setting the field to 0 or to indicate the random access procedure is initiated for the serving cell or the candidate cell, respectively.

In some implementations, the UE 104 can receive a configuration comprising/including a maximum number of PRACH transmissions associated with a random access procedure for TA acquisition of the candidate cell. The maximum number of PRACH transmissions may be different from the configuration parameter preambleTransMax representing the max number of RA preamble transmissions performed before declaring a failure. When the number of PRACH transmissions associated with a random access procedure reaches the maximum number (e.g., greater than or equal to the maximum number), the random access procedure can be considered as completed unsuccessfully (e.g., failed to complete).

### Example Aspect 1 of Implementation 1

In various implementations, the UE 104 can transmit/send/provide a message to the BS 102 of a candidate cell to indicate that the random access procedure is initiated/started for TA acquisition (e.g., for acquiring TA-related information) of the candidate cell. The message can be carried/included in or indicated by at least one of Msg1, Msg3, and/or MsgA. The BS 102 can receive the message from the UE 104 indicating that the random access procedure is initiated for the TA acquisition of the candidate cell.

If the message is carried in or indicated by Msg1, after/subsequent to transmission of the message, the UE 104 may not detect (e.g., avoid, skip, bypass, or disregard performing the detection of) a downlink control information (DCI) format associated with scheduling of the corresponding RAR and/or the UE 104 may not receive the RAR associated with the random access procedure. In various cases, not detecting certain information or signals (e.g., DCI format, etc.) can involve the UE 104 skipping the process of (not performing) the detection. In further cases, not receiving certain information or signals (e.g., RAR, etc.) can refer to or involve the UE 104 indicating to the BS 102 (e.g., via the message) not to transmit/send or to disregard/skip sending the RAR. In some cases, not receiving the certain information can involve the UE 104 filtering or discarding such information.

If the message is carried in or indicated by Msg3, after transmission of the message, the UE 104 may not detect a DCI format associated with scheduling of a physical downlink shared channel (PDSCH) that includes a UE contention resolution identity, and/or does not receive a PDSCH including a UE contention resolution identity. If the message is carried in or indicated by MsgA, after transmission of the message, the UE 104 may not detect a DCI format (e.g., DCI format 1_0) with cyclic redundancy check (CRC) bits scrambled by a corresponding MsgB-radio network temporary identifier (RNTI), and/or may not receive an MsgB. In some cases, the UE 104 may not detect or receive multiple or combinations of information, for instance, if multiple messages are indicated (e.g., more than one of Msg1, Msg3, and/or MsgA, etc.).

The random access procedure can be considered successfully completed/performed/executed after the transmission of the message by the UE 104. The message can include/comprise at least one of the following: cell RNTI (C-RNTI), RA-RNTI, MsgB-RNTI, a random access preamble index, and/or candidate cell index. In some cases, when the UE 104 determines a PRACH transmission (e.g., Msg1) associated with a PRACH occasion or a random access preamble which is configured for a candidate cell, the UE 104 may not receive a RAR message associated with the PRACH transmission, for example.

In some implementations, the UE 104 may receive/obtain/acquire a message from the BS 102 of a candidate cell. This message can indicate or be indicative of terminating/canceling or completing (e.g., successful termination or completion of) a random access procedure and/or successfully receiving a PRACH transmission after transmission of at least one of Msg1, Msg3, and/or MsgA.

Subsequently, if the message is received (from the BS 102) after transmission of Msg1, the UE 104 may not detect a DCI format associated with scheduling of the corresponding

RAR associated with the random access procedure and/or may not receive the RAR associated with the random access procedure. If the message is received after transmission of Msg3, the UE 104 may not detect a DCI format associated with scheduling of a PDSCH that includes a UE contention resolution identity, and/or may not receive a PDSCH that includes the UE contention resolution identity. If the message is received after transmission of MsgA, the UE 104 may not detect a DCI format (e.g., DCI format 1_0) with CRC bits scrambled by a corresponding MsgB-RNTI, and/or may not receive a MsgB.

In some cases, the message can have/include/contain a DCI format with CRC bits scrambled by C-RNTI, RA-RNTI, and/or MSGB-RNTI, a DCI format of which the bits of an indication field are set to specific or predetermined/predefined/configured values, and/or a DCI format including a specific indication field or a specific MAC CE. For example, when the UE 104 receives/obtains a DCI format with CRC bits scrambled by RA-RNTI, and the bits of modulation and coding scheme (MCS) field in the DCI format are set to represent an MCS index (e.g., which is reserved in a predefined table), the UE 104 may not receive an RAR message associated with the RA-RNTI.

In another example, when the UE 104 receives a DCI format in which a completingRA field is included and the field indicates to complete a random access procedure after transmission of Msg1, the UE 104 may not receive an RAR message associated with the DCI format. In further example, when the UE 104 receives a TA MAC CE in which an identification of cell or a list of identifications of cells are included, the UE 104 can consider the random access procedures associated with the cell index(es) to be completed successfully. In some cases, the TA MAC CE may include/comprise one or more timing advance-related information, where each timing advance-related information may be associated with at least one cell among the one or more cell identifications, such as in/from the list of the cell identifications.

In some implementations, the UE 104 may receive a RAR message from the BS 102. In this case, responsive to receiving the RAR message, the UE 104 can consider the random access procedure to be successfully completed or terminated according to the RAR message. The RAR message may indicate/provide at least one of the following: a PCI, a candidate cell index, a flag (of whether to complete a random access procedure), and/or timing advance-related information. UL grant field and/or temporary C-RNTI field can be reserved or absent in the RAR message.

In some cases, the UE 104 may be configured (e.g., by the BS 102, according to the received configuration) to enable or disable performing a partial random access procedure for a respective candidate cell. For example, if performing the partial random access procedure is enabled, at least one of the features/implementations discussed hereinabove can be performed for the candidate cell. In another example, if performing the partial random access procedure is disabled, the UE 104 may perform/execute the random access procedure for the candidate cell as 2-step type random access or 4-step type random access. In this example, where performing the random access procedure is disabled, the UE 104 may not perform one or more (or any) features of discussed hereinabove.

In some implementations, the UE 104 may receive one or more RAR messages from the BS 102. Each of the RAR messages may indicate respective timing advance-related information associated with a corresponding candidate cell. The UE 104 may determine uplink transmission timing associated with a cell indicated by a cell switch message based on or according to the timing advance-related information associated with the corresponding candidate cell.

In some aspects, the UE 104 may receive a cell switch message from the BS 102 indicating a cell index. The cell index can be associated with one of the configured candidate cells. The cell switch message may indicate timing advance-related information associated with the cell index. In some cases, if the random access procedure is performed/executed as 2-step type random access or 4-step type random access, the timing advance-related information may be present or absent. In some other cases, if the random access procedure is performed according to the implementation above, e.g., the random access procedure is completed in advance, the timing advance-related information can be present.

In some implementations herein, completing a random access procedure can correspond to or refer to terminating a random access procedure and/or canceling the various latter steps of the random access procedure. In certain implementations herein, the reception/acquisition of the message (e.g., from the BS 102) indicative of completing/terminating a random access procedure or successfully receiving a PRACH transmission, the RAR message and/or the cell switch message may be associated with at least one of TCI state, spatial relation, resource set for DL-RS, search space, CORESET, and/or CORESETPool which may be associated with the source cell or a candidate cell.

### Example Aspect 2 of Implementation 1

In some configurations, for the transmission of a random access preamble, the random access network temporary identifier (RA-RNTI) associated with the PRACH occasion in which the random access preamble is transmitted/provided/sent can be computed as: RA-RNTI=1+s_id+14×t_id+14×80×f_id+14×80×8×ul_carrier_id+14×80×8×2×cell_id. For example, the BS 102 can determine the RA-RNTI as a function of an index of the candidate cell associated with the transmission of the random access preamble (cell_id).

In some implementations, for MsgA transmission, the MSGB-RNTI associated with the PRACH occasion in which the random access preamble is transmitted can be computed as: MSGB-RNTI=1+s_id+14×t_id+14×80×f_id+14×80×8×ul_carrier_id+14×80×8×2×cell_id+14×80×8×2×cell_total. For example, the BS 102 can determine this MSGB-RNTI as a function of the cell_id and a cell_total.

In certain implementations herein, s_id can include, correspond to, or refer to the index (e.g., integer value) of the first orthogonal frequency division multiplexing (OFDM) symbol of the PRACH occasion (e.g., 0≤s_id<14). The t_id can be the index of the first slot of the PRACH occasion in a system frame (e.g., 0≤t_id<80). The f_id can be the index of the PRACH occasion in the frequency domain (e.g., 0≤f_id<8). The ul_carrier_id can be the UL carrier identifier (e.g., index or integer value) used for random access preamble transmission (e.g., 0 for NUL carrier and 1 for SUL carrier, or vice versa depending on the configuration).

The BS 102 can determine the parameter cell_total by or based on a maximum (supported) number of candidate cells according to the capability of the UE 104, a number of configured candidate cells, and/or a defined/fixed/configured value. The defined/fixed value can be one of/from {1, 2, 3, 4, 5, 6, 7} and/or configured to be one of {1, 2, 3, 4, 5, 6, 7}. The parameter cell_id can be an integer value (e.g., index of the cell associated with the random access preamble transmission) equal to or larger than zero, such as for source cell and/or other candidate cells (e.g., not the corresponding candidate cell associated with the respective BS 102). The parameter cell_id can be an integer value smaller than or equal to a value of cell_total (e.g., 0≤cell_id≤cell_total). In some cases, the UE capability can be represented by max NumberTA-Mobility.

### Example Aspect 3 of Implementation 1

In some aspects, the UE 104 may not receive a RAR message associated with a candidate cell, a message indicative of completing a random access procedure, and/or a message indicative of successfully receiving a PRACH transmission after/subsequent to receiving a cell switch command. In some implementations, the UE 104 may be configured with a timing advance-related timer for a candidate cell. For example, the BS 102 can send/transmit/provide a configuration to configure the UE 104 with the timing advance-related timer for the candidate cell. In this case where the timing advance-related timer is configured, when at least one of the timing advance-related information, a message indicative of completing a random access procedure, and/or a message indicative of successfully receiving a PRACH transmission is received by the UE 104, the MAC entity may start/initiate, restart, or stop/cancel/terminate the timing advance related timer. When the timing advance-related timer expires/time-out, the UE 104 may initiate a random access procedure associated with the candidate cell.

In some implementations, the UE 104 may be configured with a time period value (e.g., predetermined/predefined time period) for a candidate cell. In this case, when the time duration since the most recent/last/previous transmission of Msg1 and/or MsgA is greater than the time period value, or when the time duration since the last reception/acquisition of timing advance-related information, a message indicative of completing a random access procedure, and/or a message indicative of successfully receiving a PRACH transmission is greater than (or equal to) the time period value, the UE 104 may initiate a random access procedure associated with the candidate cell. The time period value may be configured to one or more milliseconds, sub-slots, slots, sub-frames, and/or frames, such as according to the configuration from the BS 102.

### Example Implementation 2: Timing Advance-Related Message based on Sounding Reference Signal

In various configurations, the systems and methods of the technical solution can determine and/or indicate the timing advance related information associated with a candidate cell based on or according to transmission and/or reception of sounding reference signals (SRSs). The timing advance-related message/signal associated with a candidate cell (of a respective BS 102 or network) can be determined based on a message from the BS 102. The message can be determined by the BS 102 based on the transmitted/provided SRS from the UE 104. The message can be carried in at least one of a MAC CE and/or a DCI format, among other signalings.

### Example Aspect 1 of Implementation 2

In some aspects, prior to or before the transmission of SRS, the UE 104 can be configured with one or more SRS resources or SRS resource sets associated with timing advance acquisition. For example, the configuration from the BS 102 to the UE 104 can include a configuration of one or more SRS resources or SRS resource sets associated with the timing advance acquisition.

The UE 104 can be configured with a list of SRS-Resources, a list of SRS-PosResources, a list of SRS-TAResources, a list of SRS-ResourceSets, a list of SRS-PosResourceSets, and/or a list of SRS-TAResourceSets. Each resource set (e.g., SRS resource set) can provide/indicate or define a set of SRS-Resources, SRS-PosResources, and/or SRS-TAResources, among other information. The one or more SRS resources or SRS resource sets associated with timing advance acquisition may be related to/with the list of SRS-TAResources and/or SRS-TAResourceSets, for example. In some cases, the one or more SRS resources or SRS resource sets associated with timing advance acquisition may be associated with at least one of: a candidate cell, and/or a downlink reference signal (DL-RS) of the candidate cell.

In some cases, the UE 104 can transmit/send an SRS transmission to the BS 102 of a candidate cell (e.g., using the one or more SRS resources or SRS resource sets). The SRS transmission may correspond to an SRS activation or deactivation MAC CE and/or a DCI signaling or format. In various cases, the SRS transmission can be associated with a candidate cell. A field in the SRS activation or deactivation MAC CE or the DCI signaling may indicate that the SRS transmission is activated/initiated/enabled or triggered for timing advance acquisition of the candidate cell.

In some other cases, the UE 104 may transmit an SRS transmission for uplink timing advance acquisition, for instance, in case a time period since the last transmission of SRS for uplink timing advance acquisition is greater than (or equal to) a threshold value or a time period (e.g., time limit) since the last reception of the network message (e.g., message from the BS 102) is greater than (or equal to) the threshold value. The threshold value can be configured, predetermined, or predefined for a respective candidate cell, and/or be predefined based on or according to the configuration of the respective candidate cell. The network message can indicate a timing advance-related message associated with a candidate cell or a candidate cell index, and/or indicate that an SRS transmission for uplink timing advance acquisition is received successfully.

In some implementations, the UE 104 may be configured with a timing advance-related timer for a candidate cell. The timer can start or restart when the UE 104 receives a message from the BS 102 (e.g., network message). If the timer expires, the UE 104 may transmit/provide/send an SRS (transmission) for uplink timing advance acquisition for the candidate cell. The network message can indicate a timing advance-related information (or message) associated with a candidate cell or a candidate cell index, and/or indicate that an SRS transmission for uplink timing advance acquisition is received successfully.

### Example Aspect 2 of Implementation 2

In some aspects, the UE 104 may determine an uplink transmission timing of an SRS transmission associated with timing advance acquisition for a candidate cell based on or according to a timing advance value and/or a downlink timing. In some configurations, the timing advance value can include, correspond to, or be one of: zero, a timing advance value (e.g., integer value) associated with the source cell, a timing advance value associated with a cell different from the candidate cell (e.g., of the BS 102), or timing advance value associated with the candidate cell. The UE 104 may determine the timing advance value associated with the candidate cell according to or based on the steps/procedures/features discussed in conjunction with at least one of example implementation 1 or example implementation 3.

In some configurations, the downlink timing can include or be one of: the downlink timing associated with the source cell, the downlink timing associated with the candidate cell, or the downlink timing associated with a cell different from the candidate cell. In some cases, the UE 104 may determine a transmission power for an SRS transmission based on open loop power control parameter configured for the SRS transmission, and/or path loss computed/calculated/determined by the UE 104 using a reference signal associated with the SRS transmission.

In some cases, the UE 104 may determine a transmission power for an SRS transmission based on open loop power control parameter configured for the SRS transmission, and/or path loss computed by the UE 104 using a reference signal associated with the SRS transmission and a TPC command included/filed in a DCI signaling/format. The DCI signaling can be a DCI format 2_3, a DCI triggering/activating the SRS transmission, a DCI associated with the latest/most recent PUSCH transmission before the SRS transmission, and/or a DCI format for PDCCH order.

### Example Aspect 3 of Implementation 2

In some aspects, after an SRS transmission for uplink timing advance acquisition, the UE 104 can receive a message/information/signal indicative of an index of a candidate cell. The UE 104 may cancel/terminate the activated/triggered transmission of SRS for uplink timing advance acquisition associated with the candidate cell. In some other aspects, the UE 104 may not receive a (e.g., first) message indicative of an index of a candidate cell within a time period/window/duration since/from/relative to the SRS transmission for uplink timing advance acquisition associated with the candidate cell. The time period can be configured for an SRS resource, an SRS resource set, and/or a candidate cell associated with the SRS transmission. In such cases, the UE 104 can transmit/send another (e.g., second) message to the BS 102 to indicate that timing advance acquisition for the candidate cell has failed or is not successful.

In some cases, the UE 104 may transmit a message indicating a timing advance-related information. The UE 104 can determine an uplink timing advance value associated with the candidate cell indicated by the message according to the timing advance-related information. In various aspects, the message can be carried in a MAC CE, and/or a DCI format, among other types of signalings.

### Example Implementation 3: Timing Advance-Related Message based on Downlink Timing

In various configurations, the systems and methods of the technical solution may determine and/or indicate the timing advance-related information associated with a candidate cell based on or according to the downlink timing of the candidate cell and at least one other cell. The UE 104 may determine a downlink timing of a cell based on the reception of a DL-RS associated with the cell. The UE 104 may determine the timing advance-related information associated with the candidate cell based on a reception of a DL-RS associated with the candidate cell and a reception of a DL-RS associated with another cell. The at least one other cell can be the source cell or a cell different from the candidate cell (e.g., a second candidate cell).

In some implementations, the UE 104 can determine the timing advance value associated with the candidate cell based on the difference (e.g., delta) between the downlink timing of the candidate cell and the one other cell, and/or a timing advance-related information associated with the one other cell. For example, the difference between downlink timing of a downlink frame for the source cell and a candidate cell can correspond to or be represented as T_{rx_diff}. The T_{rx_diff} can be positive (e.g., value) if the downlink timing of a downlink frame for the source cell is earlier than that for the candidate cell. Otherwise, if the downlink timing of the downlink frame from the source cell is later than for the candidate cell, the T_{rx_diff} can be negative. The timing advance value associated with the source cell can be represented as N_{TA,0}. The UE 104 can determine the timing advance value associated with the candidate cell to be N_{TA,0}+2×T_{rx_diff}, for example.

In another example, the difference between the downlink timing of a downlink frame for the source cell and a candidate cell can be T_{rx_diff}, and the timing advance command associated with the source cell can be T_{A,0}. In this example, the UE 104 can determine the timing advance value associated with the candidate cell to be N_{TA,new}=N_{TA,old}+N_{TAC,0}+2×T_{rx_diff}, where N_{TA,old} can represent the current TA value for the candidate cell, and N_{TAC,0} can be determined based on T_{A,0}.

In some implementations, the UE 104 may receive/obtain/acquire a message (e.g., from a candidate cell) indicative of or including a TA assistance value associated with the candidate cell. Responsive to receiving the message, the UE 104 can determine a timing advance value associated with a candidate cell based on or according to at least one of the difference between the downlink timing of the candidate cell and the one other cell, the timing advance-related information associated with the one other cell, and/or the TA assistance value.

For example, the difference between the downlink timing of a downlink frame for the source cell and a candidate cell can be T_{rx_diff}, the timing advance value associated with the source cell can be N_{TA,0}, and the TA assistance value can be N_{TA_delta}. The UE 104 can determine the timing advance value associated with the candidate cell according to the following formula: N_{TA,0}+2×T_{rx_diff}+N_{TA_delta}. In another example, the difference between the downlink timing of a downlink frame for the source cell and a candidate cell can be T_{rx_diff}, and the timing advance command associated with the source cell can be T_{A,0}. In this example, the UE 104 can determine the timing advance value associated with the candidate cell to be N_{TA_new}=N_{TA,old}+N_{TAC,0}+2×T_{rx_diff}+N_{TA_delta}. In various configurations, the TA assistance value can be transmitted in an RRC message, a MAC CE, and/or DCI format, among other types of signalings.

In some implementations, the transmission of SRS and/or PRACH for timing advance acquisition can be triggered or activated/initiated/performed in the case/situation that the difference between the downlink timing of the candidate cell and the one other cell is greater than (or in some cases equal to) a threshold value. The UE 104 may determine the transmission timing of the SRS and/or PRACH transmission using the downlink timing of the corresponding candidate cell and/or the one other cell as a reference, for example. In some cases, the UE 104 may determine the transmission timing of the SRS and/or PRACH transmission according to a timing advance value, which may be the same as, for example, the timing advance value described in conjunction with example aspect 2 of implementation 2.

In some implementations, the UE 104 may transmit a message to the BS 102 (e.g., the serving cell) including the difference between the downlink timing of the candidate cell and the one other cell and the index of the candidate cell in the case that the difference between downlink timing of the candidate cell and the one other cell is greater than a threshold value. In various implementations discussed herein, the threshold value can be configured/updated/provided for a candidate cell, and/or be predefined according to the configuration of the candidate cell.

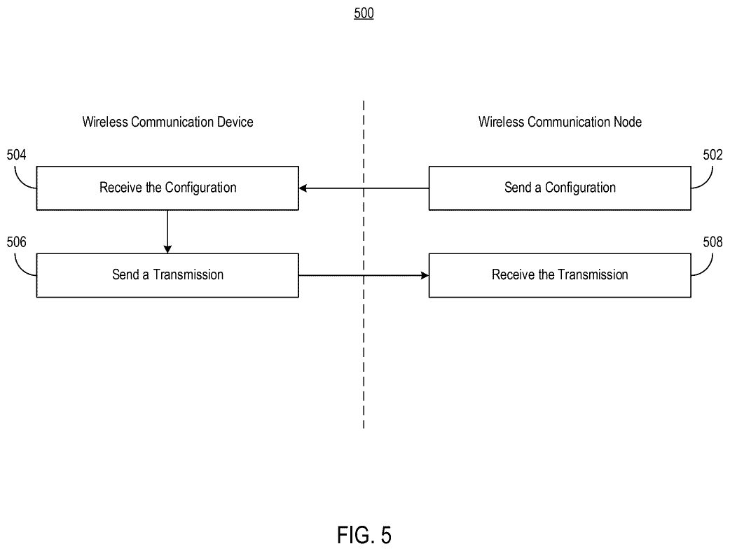

Referring now to FIG. 5, depicted is a flow diagram of a method 500 for uplink timing alignment for inter-cell mobility. The method 500 may be implemented using or performed by any of the components detailed above, such as the UE 104 or 204 and BS 102 or 202, among others. In overview, a wireless communication node can send a configuration to a wireless communication device, at operation 702. At operation 704, the wireless communication device can receive the configuration from the wireless communication node. At operation 706, the wireless communication device can send a transmission to the wireless communication node. At operation 708, the wireless communication node can receive the transmission from the wireless communication device.

In further detail, at operation 702, a wireless communication node (e.g., BS, gNB, or TRP) of a candidate cell for a wireless communication device (e.g., UE) can send/transmit/provide a configuration associated with the candidate cell to the wireless communication device. The configuration can configure the wireless communication device for TA acquisition during or before cell switching. At operation 704, the wireless communication device can receive/acquire/obtain the configuration associated with the candidate cell from the wireless communication node.

At operation 706, the wireless communication device can send a transmission to the wireless communication node according to the configuration. At operation 708, the wireless communication node can receive the transmission sent by the wireless communication device according to the configuration.

In various configurations, the configuration can include/comprise a configuration of a random access channel. The transmission can include a physical random access channel (PRACH) transmission. In such configurations, the wireless communication device can initiate/start/execute/perform a random access procedure associated with the candidate cell according to the configuration or according to a message/information from the wireless communication node indicative of at least one PRACH transmission parameter for the candidate cell.

In some implementations, the wireless communication node can receive a message from the wireless communication device to indicate that a random access procedure is initiated for acquiring timing advance (TA) related information of the candidate cell. In some cases, at least one of: after sending the message, the wireless communication device may not detect (e.g., skip, avoid, or bypass detecting) a downlink control information (DCI) format associated with scheduling of a random access response (RAR) associated with the random access procedure, and/or may not receive the RAR; after sending the message, the wireless communication device may not detect a DCI format associated with scheduling of a physical downlink shared channel (PDSCH) that includes a user equipment (UE) contention resolution identity, and/or may not receive the PDSCH that includes the UE contention resolution identity; after sending the message, the wireless communication device may not detect a DCI format with cyclic redundancy check (CRC) bits scrambled by a corresponding MsgB radio network temporary identifier (RNTI), and/or may not receive a MsgB; and/or the message can include at least one of: a cell RNTI (C-RNTI), a random access RNTI (RA-RNTI), a MsgB RNTI, a random access preamble index, and/or a candidate cell index.

In some implementations, the wireless communication node can send a message indicative of terminating or completing a random access procedure and/or successfully receiving/obtaining a PRACH transmission after reception of Msg1, Msg3, and/or MsgA to the wireless communication device. Depending on whether the message is sent after receiving at least one of the Msg1, Msg, and/or MsgA, at least one of: the wireless communication device may not detect a downlink control information (DCI) format associated with scheduling of a random access response (RAR) associated with the random access procedure, and/or may not receive the RAR; the wireless communication device may not detect a DCI format associated with scheduling of a physical downlink shared channel (PDSCH) that includes a user equipment (UE) contention resolution identity, and/or may not receive the PDSCH that includes the UE contention resolution identity; the wireless communication device may not detect a DCI format with cyclic redundancy check (CRC) bits scrambled by a corresponding MsgB radio network temporary identifier (RNTI), and/or may not receive a MsgB; and/or the message can include a DCI format with CRC bits scrambled by a cell RNTI (C-RNTI), a random access RNTI (RA-RNTI) and/or a MsgB RNTI, and/or a DCI format with an indication field having bits set to specific values, and/or a DCI format with a specific indication field, and/or a specific medium access control control element (MAC CE) signaling. Responsive to these communications between the wireless communication node and the wireless communication device (e.g., for partial random access procedure), the systems and methods can reduce/minimize latency for cell switching, as the information is communicated before or during the cell switching.

In some implementations, the at least one of: the wireless communication node may send a random access response (RAR) message indicative of terminating or successfully completing a random access procedure to the wireless communication device, where the RAR message can indicate at least one of: a physical cell index (PCI), a candidate cell index, a flag of whether to complete or terminate the random access procedure, and/or a timing advance (TA) related information; the wireless communication node may send a configuration to the wireless communication device to enable or disable the wireless communication device to perform partial random access procedure, where when performing the partial random access procedure is enabled, performing one or more steps of any of the implementations or features hereinabove, and/or when performing the partial random access procedure is disabled, random access can be performed according to a 2-step type random access or a 4-step type random access procedure; the wireless communication node can send one or more RAR messages to the wireless communication device. Each of the one or more RAR messages may indicate TA-related information associated with a corresponding candidate cell, and the wireless communication device can determine (or compute) uplink transmission timing associated with the corresponding candidate cell indicated by a cell switch message based at least on or according to at least the TA related information associated with the corresponding candidate cell; and/or the wireless communication node may send a cell switch message to the wireless communication device, indicating at least one of: a cell index, and/or TA related information associated with the cell index.

In some implementations, at least one of the following determination can be performed taking cell index into account: the wireless communication node for transmission of a random access preamble can determine a random access network temporary identifier (RA-RNTI) associated with a PRACH occasion in which the random access preamble is transmitted, as a function of an index of the candidate cell associated with the transmission of the random access preamble (cell_id); and/or the wireless communication node for transmission of a MsgA can determine a MSGB network temporary identifier (RNTI) associated with a PRACH occasion in which the random access preamble is transmitted, as a function of the cell_id, and a cell_total. In this case, the cell_total can be or correspond to a maximum number of candidate cells supported according to a capability of the wireless communication device, and/or a number of configured candidate cells, and/or a defined/fixed/configured value. The cell_id can be an integer value equal to or larger than zero, and/or smaller than or equal to a value of cell_total. The defined value can be or be configured to one from/of {1, 2, 3, 4, 5, 6, 7}.

In some implementations, the wireless communication node may send a configuration to the wireless communication device to configure the wireless communication device with a timing advance (TA) related timer for the candidate cell (e.g., for contention-based random access (CBRA) for TA acquisition during cell switching). In this case, when the timing advance related timer expires, the wireless communication device may initiate a random access procedure associated with the candidate cell.

In various configurations, at least one of: the configuration can include a configuration of one or more sounding reference signal (SRS) resources and/or SRS resource sets associated with timing advance (TA) acquisition; the transmission can include a SRS transmission; the SRS transmission can be for uplink timing advance acquisition for the candidate cell; and/or the one or more SRS resources and/or SRS resource sets may be associated with at least one of: the candidate cell, and/or a downlink reference signal (DL-RS) of the candidate cell.

In some implementations, the wireless communication node may receive the SRS transmission from the wireless communication device, where at least one of: the SRS transmission may correspond to an SRS activation or deactivation medium access control control element (MAC CE) signaling or a downlink control information (DCI) signaling; a field in the SRS activation or deactivation MAC CE signaling or the DCI signaling can indicate that the SRS transmission is activated or triggered for timing advance acquisition of the candidate cell; and/or the SRS transmission may be associated with the candidate cell.

In some implementations, the wireless communication device can determine uplink transmission timing of the SRS transmission, associated with timing advance acquisition for the candidate cell, based at least on or according to at least a timing advance value and a downlink timing, wherein at least one of: the timing advance value can include: (i) zero, (ii) a timing advance value associated with a source cell, (3) a timing advance value associated with a cell different from the candidate cell, and/or (4) a timing advance value associated with the candidate cell; and/or the downlink timing can include: (i) a downlink timing associated with the source cell, (ii) a downlink timing associated with the candidate cell, and/or (iii) a downlink timing associated with a cell different from the candidate cell.

In some aspects, at least one of: after the SRS transmission for uplink timing advance acquisition, the wireless communication device may receive a message indicative of an index of the candidate cell, and cancel an activated/initiated or triggered transmission of SRS for uplink timing advance acquisition associated with the candidate cell; or the wireless communication device may not receive the message (e.g., first message) indicative of the index of the candidate cell within a time period relative to the SRS transmission for uplink timing advance acquisition associated with the candidate cell, where the time period may be configured for an SRS resource, an SRS resource set, and/or the candidate cell associated with the SRS transmission, and can the wireless communication device can transmit another message (e.g., second message) to the wireless communication node to indicate that the uplink timing advance acquisition for the candidate cell has failed (e.g., was not successful).

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A method comprising:
sending, by a wireless communication node of a candidate cell for a wireless communication device, a configuration associated with the candidate cell, to the wireless communication device; and
receiving, by the wireless communication node, a transmission sent by the wireless communication device according to the configuration.

2. The method of claim 1, wherein:
the configuration comprises a configuration of a random access channel, which comprises at least one of: random access (RA) preamble indexes, an indication of physical random access channel (PRACH) resources, a synchronization signal block (SSB) index, or a physical cell index (PCI); and
the transmission comprises a physical random access channel (PRACH) transmission.

3. The method of claim 2, wherein the wireless communication device initiates a random access procedure associated with the candidate cell according to the configuration or according to a message from the wireless communication node, the message indicating at least one of:
at least one PRACH transmission parameter for the candidate cell;
that initiation of the random access procedure for the candidate cell;
that initiation of the random access procedure for a serving cell; or
whether the random access procedure is initiated for the candidate cell or the serving cell.

4. The method of claim 2, comprising:
receiving, by the wireless communication node from the wireless communication device, a message to indicate that a random access procedure is initiated for acquiring timing advance (TA) related information of the candidate cell.

5. The method of claim 4, wherein at least one of:
the message comprises or is comprised in a Msg1;
after sending the message, the wireless communication device does not detect a downlink control information (DCI) format associated with scheduling of a random access response (RAR) associated with the random access procedure, or does not receive the RAR;
after sending the message, the wireless communication device does not detect a DCI format associated with scheduling of a physical downlink shared channel (PDSCH) that includes a user equipment (UE) contention resolution identity, or does not receive the PDSCH that includes the UE contention resolution identity;
after sending the message, the wireless communication device does not detect a DCI format with cyclic redundancy check (CRC) bits scrambled by a corresponding MsgB radio network temporary identifier (RNTI), or does not receive a MsgB;
after sending the message, the random access procedure is considered successfully performed or completed; or
the message comprises at least one of: a cell RNTI (C-RNTI), a random access RNTI (RA-RNTI), a MsgB RNTI, a random access preamble index, or a candidate cell index.

6. The method of claim 2, comprising:
sending, by the wireless communication node to the wireless communication device, a message indicative of terminating or completing a random access procedure or successfully receiving a PRACH transmission after reception of Msg1, Msg3 or MsgA, wherein
the wireless communication device does not detect a downlink control information (DCI) format associated with scheduling of a random access response (RAR) associated with the random access procedure, or does not receive the RAR.

7. The method of claim 2, comprising:
sending, by the wireless communication node to the wireless communication device, a cell switch message indicating at least one of: a cell index, or timing advance (TA) related information associated with the cell index, wherein at least one of:
the cell switch index is associated with one of a plurality of configured candidate cells; or
the cell switch message is associated with at least one of: a transmission configuration indication (TCI) state, a spatial relation, a resource set for downlink reference signal (DL-RS), a search space, a control resource set (CORESET), or a CORESET pool associated with a source cell.

8. A method comprising:
receiving, by a wireless communication device, from a wireless communication node of a candidate cell, a configuration associated with the candidate cell; and
sending, by the wireless communication device according to the configuration, a transmission to the wireless communication node.

9. The method of claim 8, wherein:
the configuration comprises a configuration of a random access channel, which comprises at least one of: random access (RA) preamble indexes, an indication of physical random access channel (PRACH) resources, a synchronization signal block (SSB) index, or a physical cell index (PCI); and
the transmission comprises a physical random access channel (PRACH) transmission.

10. The method of claim 9, wherein the wireless communication device initiates a random access procedure associated with the candidate cell according to the configuration or according to a message from the wireless communication node, the message indicating at least one of:
at least one PRACH transmission parameter for the candidate cell;
that initiation of the random access procedure for the candidate cell;
that initiation of the random access procedure for a serving cell; or
whether the random access procedure is initiated for the candidate cell or the serving cell.

11. The method of claim 9, comprising:
sending, by the wireless communication device to the wireless communication node, a message to indicate that a random access procedure is initiated for acquiring timing advance (TA) related information of the candidate cell.

12. The method of claim 11, wherein at least one of:
the message comprises or is comprised in a Msg1;
after sending the message, the wireless communication device does not detect a downlink control information (DCI) format associated with scheduling of a random access response (RAR) associated with the random access procedure, or does not receive the RAR;
after sending the message, the wireless communication device does not detect a DCI format associated with scheduling of a physical downlink shared channel (PDSCH) that includes a user equipment (UE) contention resolution identity, or does not receive the PDSCH that includes the UE contention resolution identity;
after sending the message, the wireless communication device does not detect a DCI format with cyclic redundancy check (CRC) bits scrambled by a corresponding MsgB radio network temporary identifier (RNTI), or does not receive a MsgB;
after sending the message, the random access procedure is considered successfully performed or completed; or
the message comprises at least one of: a cell RNTI (C-RNTI), a random access RNTI (RA-RNTI), a MsgB RNTI, a random access preamble index, or a candidate cell index.

13. The method of claim 9, comprising:
receiving, by the wireless communication device from the wireless communication node, a message indicative of terminating or completing a random access procedure or successfully receiving a PRACH transmission after reception of Msg1, Msg3 or MsgA,
wherein the wireless communication device does not detect a downlink control information (DCI) format associated with scheduling of a random access response (RAR) associated with the random access procedure, or does not receive the RAR.

14. The method of claim 9, comprising:
receiving, by the wireless communication device from the wireless communication node, a cell switch message indicating at least one of: a cell index, or timing advance (TA) related information associated with the cell index, wherein at least one of:
the cell switch index is associated with one of a plurality of configured candidate cells; or
the cell switch message is associated with at least one of: a transmission configuration indication (TCI) state, a spatial relation, a resource set for downlink reference signal (DL-RS), a search space, a control resource set (CORESET), or a CORESET pool associated with a source cell.

15. A wireless communication node f a candidate cell for a wireless communication device, comprising:
at least one processor configured to:
send, via a transceiver, a configuration associated with the candidate cell, to the wireless communication device; and
receive, via the transceiver, a transmission sent by the wireless communication device according to the configuration.

16. The wireless communication node of claim 15, wherein:
the configuration comprises a configuration of a random access channel, which comprises at least one of: random access (RA) preamble indexes, an indication of physical random access channel (PRACH) resources, a synchronization signal block (SSB) index, or a physical cell index (PCI); and
the transmission comprises a physical random access channel (PRACH) transmission.

17. The wireless communication node of claim 16, wherein the wireless communication device initiates a random access procedure associated with the candidate cell according to the configuration or according to a message from the wireless communication node, the message indicating at least one of:
at least one PRACH transmission parameter for the candidate cell;
that initiation of the random access procedure for the candidate cell;
that initiation of the random access procedure for a serving cell; or
whether the random access procedure is initiated for the candidate cell or the serving cell.

18. A wireless communication device, comprising:
at least one processor configured to:
receive, via a transceiver from a wireless communication node of a candidate cell, a configuration associated with the candidate cell; and
send, via the transceiver according to the configuration, a transmission to the wireless communication node.

19. The method of claim 18, wherein:
the configuration comprises a configuration of a random access channel, which comprises at least one of: random access (RA) preamble indexes, an indication of physical random access channel (PRACH) resources, a synchronization signal block (SSB) index, or a physical cell index (PCI); and
the transmission comprises a physical random access channel (PRACH) transmission.

20. The method of claim 19, wherein the wireless communication device initiates a random access procedure associated with the candidate cell according to the configuration or according to a message from the wireless communication node, the message indicating at least one of:
at least one PRACH transmission parameter for the candidate cell;
that initiation of the random access procedure for the candidate cell;
that initiation of the random access procedure for a serving cell; or
whether the random access procedure is initiated for the candidate cell or the serving cell.
